(19) United States
(12) Patent Application Publication
(10) Pub. No.: US 2026/0064462 A1
(43) Pub. Date: Mar. 5, 2026

(54) PORT SELECTION FOR HARDWARE QUEUING MANAGEMENT DEVICE

(71) Applicant: Intel Corporation, Santa Clara, CA (US)

(72) Inventors: Pushpendra Kumar, Agra (IN); Amruta Misra, Bangalore (IN); Niall McDonnell, Limerick (IE); Ambalavanar Arulambalam, Center Valley, PA (US); Ximing Chen, Ringoes, NJ (US); Paul Beatty, Akron, PA (US); Pravin Pathak, Bridgewater, NJ (US)

(73) Assignee: Intel Corporation, Santa Clara, CA (US)

(21) Appl. No.: 19/106,242

(22) PCT Filed: Sep. 27, 2022
(86) PCT No.: PCT/US2022/044811

§ 371 Date: Feb. 25, 2025

(51) Int. Cl. G06F 9/48; G06F 9/4401; G06F 11/34

(52) U.S. Cl. CPC G06F 9/4881; G06F 9/4401; G06F 11/3409

(57) ABSTRACT

In an embodiment, a processor may include multiple processing engines and multiple hardware queue manager (HQM) devices. Each HQM device is to queue data requests for a different subset of the plurality of processing engines. At least one processing engine is to execute a first set of instructions to: detect a first enqueue instruction to enqueue data in a first HQM device of the plurality of HQM devices; in response to a detection of the first enqueue instruction, perform a look-up of the first HQM device in a data structure to determine a recommended port for the first HQM device; and transmit the first enqueue instruction using the recommended port for the first HQM device.

### FIELD OF INVENTION

Embodiments relate generally to computer systems. More particularly, embodiments are related to scheduling tasks in computer processors.

### BACKGROUND

Advances in semiconductor processing and logic design have permitted an increase in the amount of logic that may be present on integrated circuit devices. As a result, computer system configurations have evolved from a single or multiple integrated circuits in a system to multiple hardware threads, multiple processing cores, multiple devices, and/or complete systems on individual integrated circuits.

### BRIEF DESCRIPTION OF THE DRAWINGS

FIGS. 1A-1B are block diagrams of an example system in accordance with one or more embodiments.

FIGS. 2A-2B is an illustration of example software implementations in accordance with one or more embodiments.

FIG. 3A is a flow diagram of an example method in accordance with one or more embodiments.

FIG. 3B is an illustration of example pseudo-code in accordance with one or more embodiments.

FIG. 4 is a block diagram of an example recommendation table in accordance with one or more embodiments.

FIG. 5 is a flow diagram of an example method in accordance with one or more embodiments.

FIG. 6 is a block diagram of an example system in accordance with one or more embodiments.

FIG. 7 is a block diagram of an example system in accordance with one or more embodiments.

FIG. 8 is an illustration of an example storage medium in accordance with one or more embodiments.

### DETAILED DESCRIPTION

In some examples, computer processors may include multiple processing engines or “cores.” Further, sets of cores may be arranged as modules or “tiles” that may also include various processing circuitry, cache memory, interface circuitry and so forth. In some examples, communications between the cores in a multi-core processor (also referred to as “core-to-core” or “C2C” communications) may be used by computer applications such as packet processing, high-performance computing, machine learning, and so forth. The C2C communications may be used to send and/or receive data and/or commands between cores. For example, a first core in a processor (e.g., a “producer” core) may send a message to a second core (e.g., a “consumer” core) in the same processor. The messages may be temporarily stored in queues to control the timing of processing each message.

In some examples, the latency associated with processing the queues may become large enough to negatively impact the performance of the processor. Accordingly, some processors may include one or more hardware queuing manager (HQM) device(s) to accelerate the processing of the queues, with each HQM device including multiple ports to receive and send messages. Each port may be accessed via a particular address that is assigned to the port. In some examples, when producer core sends a message to a particular HQM device, the port address used for that message may be determined according to a predefined order (e.g., using a rotating list of addresses). However, in some examples, using different port addresses may cause messages to follow different routes to the particular HQM device. For example, messages using different port addresses may be routed to different caching agents located in different tiles. As such, some messages may travel over longer data paths than other messages, and therefore the messages with longer data paths may involve higher latencies (e.g., require longer time periods) to arrive at the HQM device. However, if one or messages from a given core involve a relatively high latency, it becomes increasing likely that the number of pending (e.g., uncompleted) messages from that producer core reaches a maximum allowed number of pending messages. Accordingly, in such situations, the producer core may become stalled while waiting for its pending messages to be completed. In this manner, using messages with relative high latencies may reduce the performance of the processor when performing C2C tasks.

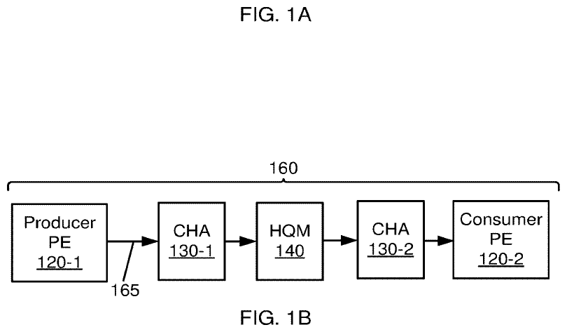

In accordance with some embodiments, a processor may include functionality to identify a port in a HQM device that is recommended for transmitting a message (referred to herein as the “recommended port”). In some embodiments, the recommended port may provide the best available performance metric for transmitting the message (e.g., the fastest time of transmission). When a message is to be transmitted to a particular HQM device, the message is transmitted to the recommended port address. In this manner, the performance of the producer core may be improved. For example, using the recommended port address may reduce the likelihood of stalling the producer core. Various details of some embodiments are described further below with reference to FIGS. 1A-5.

### FIGS. 1A-1B—Example System

FIG. 1A shows is a block diagram of an example processor 110 in accordance with some embodiments. The processor 110 may be a hardware processing device (e.g., a central processing unit (CPU), a System on a Chip (SoC), and so forth). The processor 110 may be coupled to a system memory 105.

In some embodiments, the processor 110 may be a processing device that is specialized for use in a data center or a distributed computing system. For example, the processor 110 may be (or may include multiple instances of) an infrastructure processing unit (IPU), an infrastructure processing unit (IPU), and so forth. In such embodiments, the processor 110 may include a high-performance network interface, one or more processing engines, one or more acceleration engines, and so forth.

In one or more embodiments, the system memory 105 may be implemented with any type(s) of computer memory (e.g., dynamic random-access memory (DRAM), static random-access memory (SRAM), non-volatile memory (NVM), a combination of DRAM and NVM, etc.).

As shown in FIG. 1A, the processor 110 can include multiple tiles 115 that are interconnected by a mesh network 150. Each tile 115 may be a discrete unit that includes multiple processing engines 120 (also referred to herein as “cores 120,” “processing circuits 120,” or “processing cores 120”), one or more caching home agents (CHAs) 130, and a hardware queue manager (HQM) device 140. The processing engines 120 may include general purpose processing engines, graphics processing engines, math processing engines, network processing engines, cryptography processing engines, and so forth. The processing engines 120 may execute software instructions.

In some embodiments, the multiple CHAs 130 (e.g., included in the tiles 115) may be hardware units (e.g., circuitry) that maintain a distributed cache coherence directory. Each CHA 130 may be assigned a set of memory addresses that represent a portion of the directory. In some embodiments, a hash function is used to determine which address is owned by which CHA 130. An access to a particular memory address go to the CHA 130 that owns that address, in order to maintain cache coherency for that memory address.

In some embodiments, each HQM device 140 may be a hardware unit to manage queues for C2C communications. Further, each HQM device 140 may perform load balancing across multiple cores 120. For example, an HQM device 140 may be implemented as a Dynamic Load Balancer (DLB) device. Each HQM device 140 may include multiple ports to receive and send C2C messages, with each port being accessed via a particular address that is assigned to that port.

Referring now to FIG. 1B, shown is an example data path 160 of a core-to-core (“C2C”) message 165. As shown, the C2C message 165 is transmitted from a producer PE 120-1 to a first CHA 130-1, and is then transmitted to a HQM device 140. For example, the C2C message 165 may be a MOVDIR64B instruction issued by the producer PE 120-1. The HQM device 140 may queue the C2C message 165 in an internal physical queue, and then may transmit the C2C message to the second CHA 130-2. Further, the second CHA 130-2 may transmit the C2C message to the consumer PE 120-2. In some embodiments, the C2C message 165 may specify a particular port address of a specific HQM device 140 (e.g., the HQM device 140 included in a particular tile 115). For example, the port address may be a memory mapped input/output (MMIO) address of a producer port of the HQM device 140.

In some embodiments, the port address specified in the C2C message 165 may be assigned (e.g., hashed) to a particular CHA 130), and therefore messages using different port addresses may have different route lengths via the respective CHAS 130. For example, a message using a first port address may be hashed to a CHA 130 located on the same tile 115 as the HQM device 140, and therefore the route from the CHA 130 to the HQM device 140 may be relatively short. However, in this example, a message using a second port address may be hashed to a CHA 130 on the different tile 115 as the HQM device 140, and therefore the route from the CHA 130 to the HQM device 140 may be relatively long. Therefore, in this example, the message using the first port address may be delivered to the HQM device 140 in a shorter time (e.g., have less latency) that the message using the second port address. Accordingly, traversing the data path 160 may involve different latencies (e.g., time durations) depending on the port address specified in the message 165. Further, traversing the data path 160 may involve other performance metrics (e.g., jitter, throughput, error rate, etc.) depending on the port address specified in the message 165.

In some embodiments, the processor 110 may include functionality to determine one or more performance metrics (e.g., latency characteristics) of each port in a HQM device 140, and to determine which port provides the best performance metric(s) when transmitted to the HQM device 140. In some embodiments, a data structure (e.g., a table) may store the recommended ports for different HQM devices 140. When a message 165 is to be transmitted to a particular HQM device 140, the data structure may be used to (e.g., via a look-up) to identify the recommended port for that particular HQM device 140. Further, the message 165 may be transmitted to the recommended port address. In this manner, the performance of data communication may be improved.

Note that, while FIG. 1B shows the message 165 as being transmitted between two processing cores, embodiments are not limited in this regard. For example, it is contemplated that the message 165 may be transmitted, via a HQM device 140, to or from a memory device, controller, accelerator, and so forth (e.g., a local memory, a far memory, a tiered memory, a multi-level memory, a memory accelerator, a local memory controller, a far memory controller, etc.).

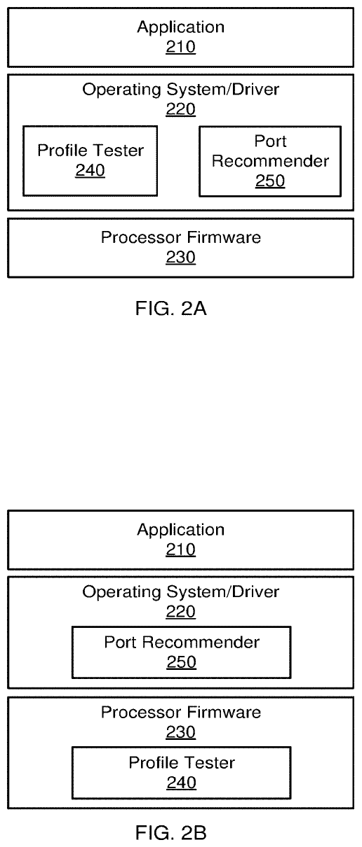

### FIGS. 2A-2B—Example Software Implementations

FIGS. 2A-2B show example software implementations, in accordance with one or more embodiments. The example software implementations may include an application 210, an operating system or driver (OS/driver) 220, and processor firmware 230. The OS/driver 220 may comprise a driver for a hardware queue manager (HQM) device (e.g., the HQM device 140 shown in FIG. 1A).

In some embodiments, as shown in FIG. 2A, the OS/driver 220 may implement a profile tester 240 and a port recommender 250. In other embodiments, as shown in FIG. 2B, the processor firmware 230 may implement the profile tester 240, and the OS/driver 220 may implement the port recommender 250. Other variations are possible.

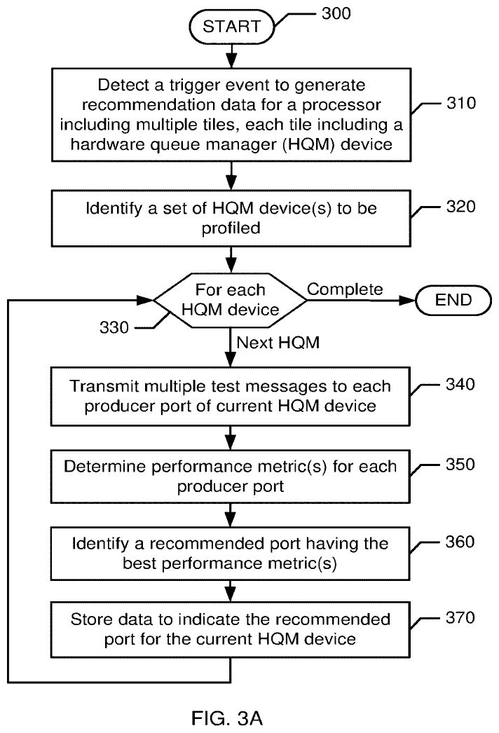

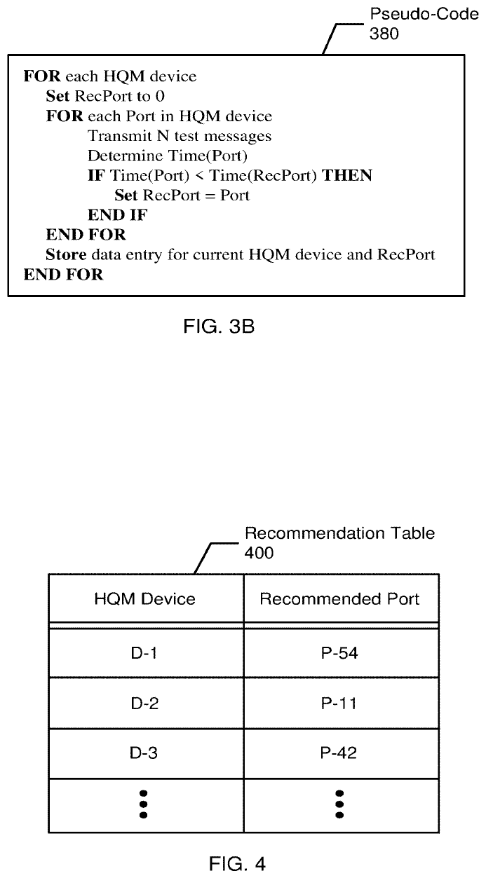

In some embodiments, the profile tester 240 may perform tests for each port in the HQM devices 140, and may thereby determine performance metric(s) for each port. Further, the profile tester 240 may identify the recommended port of each HQM device 140 based on the performance metric(s) (e.g., the port providing the fastest transmission of messages from a producer PE 120 to the HQM device 140), and may store one or more recommended ports of each HQM device 140 in a data structure (e.g., a table, array, etc.). The functionality of the profile tester 240 is described further below with reference to FIGS. 3A-4.

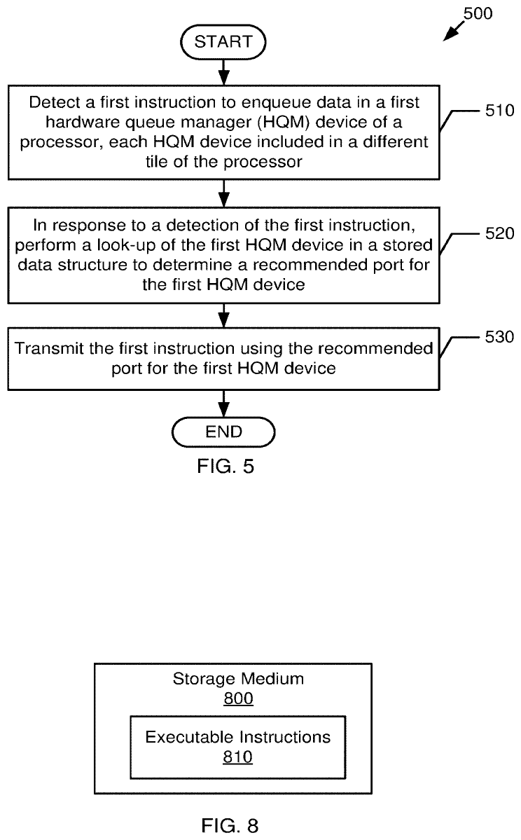

In some embodiments, the processor 110 may implement a port recommender to detect a message 165 that is to be transmitted to a particular HQM device 140, perform a look-up in the data structure to determine the recommended port for that particular HQM device 140, and cause the message 165 to be transmitted to the recommended port address. In this manner, the message may be transmitted to the HQM device 140 with improved performance characteristics (e.g., low latency). The functionality of the port recommender 250 is described further below with reference to FIG. 5.

In one or more embodiments, the profile tester 240 and/or the port recommender 250 may be implemented in computer executed instructions stored in a non-transitory machine-readable medium, such as an optical, semiconductor, or magnetic storage device. However, in other embodiments, the profile tester 240 and/or the port recommender 250 may be implemented in hardware (e.g., processing device, circuitry, dedicated logic, programmable logic, microcode, etc.).

### FIGS. 3A-4—Example Method

FIG. 3A shows is a flow diagram of a method 300, in accordance with one or more embodiments. In various embodiments, the method 300 may be performed by processing logic (e.g., processor 110 shown in FIG. 1) that may include hardware (e.g., processing device, circuitry, dedicated logic, programmable logic, microcode, etc.), software and/or firmware (e.g., instructions run on a processing device), or a combination thereof. In firmware or software embodiments, the method 300 may be implemented by computer executed instructions stored in a non-transitory machine-readable medium, such as an optical, semiconductor, or magnetic storage device. The machine-readable medium may store data, which if used by at least one machine, causes the at least one machine to fabricate at least one integrated circuit to perform the method 300.

In various embodiments, the method 300 may be performed and/or repeated at different execution levels or different components. For example, the method 300 may be performed for each processing engine 120 (shown in FIG. 1A). In another example, the method 300 may be performed for each tile 115 (shown in FIG. 1A). In yet another example, the method 300 may be performed for each HQM device 140 (shown in FIG. 1A). In still another example, the method 300 may be performed once for the entire processor 110 (shown in FIG. 1A).

Block 310 may include detecting a trigger event to generate recommendation data for a processor including multiple tiles, where each tile includes a hardware queue manager (HQM) device. Block 320 may include identifying a set of HQM device(s) to be profiled. For example, referring to FIGS. 1A-2B, a profile tester 240 (e.g., software or firmware executed by a processing engine 120) detects a trigger event (e.g., a system boot-up, a system reset, a trigger command, a trigger instruction, and so forth). In response to detecting the trigger event, the profile tester 240 identifies the HQM devices 140 in the processor 110 (e.g., one HQM device 140 per tile 115) that are to be profiled to generate a recommendation table.

At block 330, a loop (defined by blocks 330-370) may be entered to process each HQM device to be profiled. Block 340 may include transmitting multiple test messages to each producer port of the current HQM device. Block 350 may include determining performance metric(s) for each producer port of the current HQM device. For example, referring to FIGS. 1A-2B, the profile tester 240 sends N test messages to each input port of the current HQM device 140, and determines the total time required to complete the N test messages. In some examples, a test message is completed when a response or acknowledgement to the test message is received. For example, each test message may be transmitted from a producer PE 120-1 to a consumer PE 120-2, and a response is then transmitted from the consumer PE 120-2 back to the producer PE 120-1. The port address used in the test message may cause the test message to be routed to a particular CHA 130 (e.g., by hashing the port address to the particular CHA 130), and the test message may then be transmitted to the corresponding producer port of the HQM device 140. In some embodiments, performing a test message may include issuing a MOVDIR64B instruction by the producer PE 120-1.

Block 360 may include identifying one or more recommended ports in the order of best performance metric(s). Block 370 may include creating one or more entries in a stored table to indicate one or more recommended ports for the current HQM device. After block 370, the method 300 may return to block 330 (e.g., to process another HQM device). For example, referring to FIGS. 1A-2B, the profile tester 240 identifies a first recommended producer port as the port of the current HQM device 140 that has the shortest test time (e.g., completed the N test messages in the shortest total time). Further, the profile tester 240 adds a new entry to a recommendation table, where the new entry identifies the recommended port for the current HQM device 140.

For example, referring to FIG. 4, shown is an example recommendation table 400. As shown, each entry of the recommendation table 400 may include a first field to identify a particular HQM device, and a second field to identify the recommended port for the particular HQM device. The recommended port may be identified by an address or identifier (e.g., a memory mapped input/output (MMIO) address).

Note that, while FIG. 4 shows an example recommendation table 400 that includes one entry per HQM device, embodiments are not limited in this regard. For example, it is contemplated that the recommendation table 400 could include a set of entries for each HQM device, with entry of the set corresponding to a different port of the HQM device. Further, the set of entries may be sorted according to one or more performance metric(s) (e.g., from shortest test time to longest test time, from most throughput to least throughput, from lowest error rate to highest error rate, and so forth). For example, the recommended port may be the port with the shortest test time that is currently available (e.g., not currently being used for another message or thread) for the identified HQM device. In another example, the recommended port may be the port with the best value of a weighted combination of multiple performance metrics (e.g., speed and throughput).

In some embodiments, one or more subsets of ports of an HQM device may be reserved for entities (e.g., customers) that have a particular priority or importance level (e.g., a service level agreement (SLA), a service level objective (SLO), and so forth). For example, a first set of ports with a highest tier of performance metrics may be reserved for customers having the highest priority level, a second set of ports having the second highest tier of performance metrics may be reserved for customers having the second highest priority level, and so forth.

Referring now to FIG. 3B, shown is example pseudo-code 380 in accordance with some embodiments. The example pseudo-code 380 may be executed by the profile tester 240 to generate a recommendation table for multiple HQM devices. As shown, the pseudo-code 380 may include an outer loop for each HQM device in a processor. At the start of each iteration of the outer loop, the recommended port (“RecPort”) is reset to zero, and an inner loop is performed for each producer port in the current HQM device. During each iteration of the inner loop, a set of N test messages are transmitted to the current port, and the total test time to complete the N test messages for the current port (“Time(Port)”) is determined. If the total test time for the current port of the current iteration is less than the total test time for the recommended port (“Time(Port)<Time(RecPort)”), then the recommended port is set to be the current port (“Set RecPort=Port”). After all iterations of the inner loop are completed (i.e, all ports of the current HQM device have been tested), a table entry is created to indicate the recommended port for the current HQM device. This may be followed by another iteration of the outer loop is performed (e.g., for the next HQM device).

Note that, while FIG. 4 shows that the recommended port information is stored in the form of a table, embodiments are not limited in this regard. For example, it is contemplated that the recommended port information may be stored using any suitable data structure or function (e.g., an array, in a hash function, and so forth).

### FIG. 5—Example Method

FIG. 5 shows is a flow diagram of a method 500, in accordance with one or more embodiments. In various embodiments, the method 500 may be performed by processing logic (e.g., processor 110 shown in FIG. 1) that may include hardware (e.g., processing device, circuitry, dedicated logic, programmable logic, microcode, etc.), software and/or firmware (e.g., instructions run on a processing device), or a combination thereof. In firmware or software embodiments, the method 500 may be implemented by computer executed instructions stored in a non-transitory machine-readable medium, such as an optical, semiconductor, or magnetic storage device. The machine-readable medium may store data, which if used by at least one machine, causes the at least one machine to fabricate at least one integrated circuit to perform the method 500.

Block 510 may include detecting a first instruction to enqueue data in a first hardware queue manager (HQM) device of a processor, each HQM device included in a different tile of the processor. Block 520 may include, in response to a detection of the first instruction, perform a look-up of the first HQM device in a stored data structure to determine a recommended port for the first HQM device. Block 530 may include transmitting the first instruction using the recommended port for the first HQM device. After block 530, the method 500 may be completed. For example, referring to FIGS. 1A-4, the port recommender 250 detects an instruction (e.g., an MOVDIR64B instruction) to enqueue data in a particular HQM device 140. In response, the port recommender 250 performs a look-up of an identifier of the particular HQM device 140 in the recommendation table 400, and thereby determines the recommended port for the particular HQM device 140. The port recommender 250 then causes the instruction to be transmitted using the recommended port of the particular HQM device 140 (e.g., transmitted to an address of the recommended port). In some examples, the recommended port may be selected from a set of entries of the recommendation table that match the identifier of the HQM device, and may be the port of the set that has the best performance metric(s) (e.g., shortest test time) and that is currently available (e.g., is not currently used by another message).

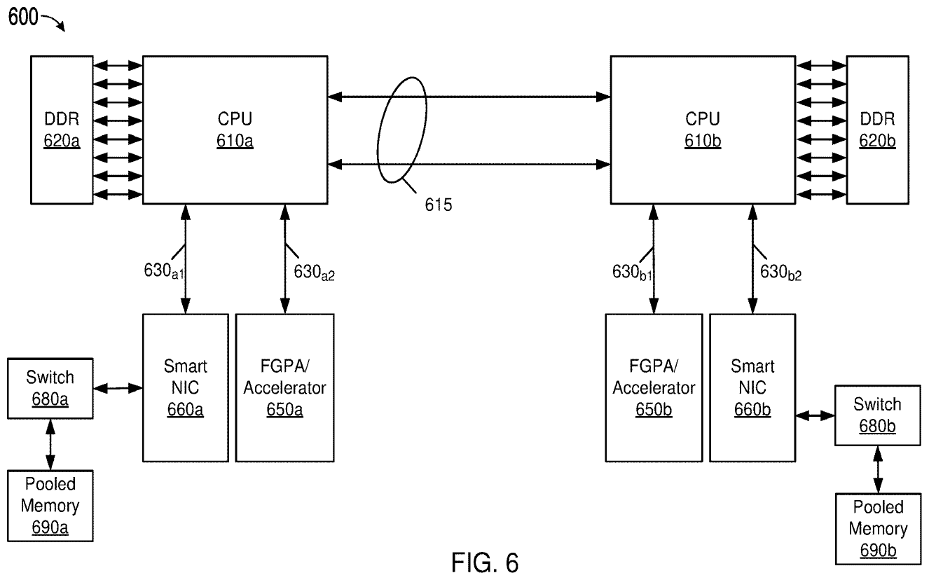

### FIG. 6—Example System

Embodiments may be implemented in a variety of other computing platforms. Referring now to FIG. 6, shown is a block diagram of a system 600 in accordance with another embodiment. In various embodiments, the system 600 may implement some or all of the components, methods, and/or operations described above with reference to FIGS. 1-5.

As shown in FIG. 6, the system 600 may be any type of computing device, and in one embodiment may be a server system such as an edge platform. In the embodiment of FIG. 6, system 600 includes multiple CPUs 610a,b that in turn couple to respective system memories 620a,b which in embodiments may be implemented as double data rate (DDR) memory. Note that CPUs 610 may couple together via an interconnect system 615, which in an embodiment can be an optical interconnect that communicates with optical circuitry (which may be included in or coupled to CPUs 610).

To enable coherent accelerator devices and/or smart adapter devices to couple to CPUs 610 by way of potentially multiple communication protocols, a plurality of interconnects 630a1-b2 may be present. In an embodiment, each interconnect 630 may be a given instance of a Compute Express Link (CXL) interconnect.

In the embodiment shown, respective CPUs 610 couple to corresponding field programmable gate arrays (FPGAs)/accelerator devices 650a,b (which may include graphics processing units (GPUs), in one embodiment. In addition CPUs 610 also couple to smart network interface circuit (NIC) devices 660a,b. In turn, smart NIC devices 660a,b couple to switches 680a,b that in turn couple to a pooled memory 690a,b such as a persistent memory.

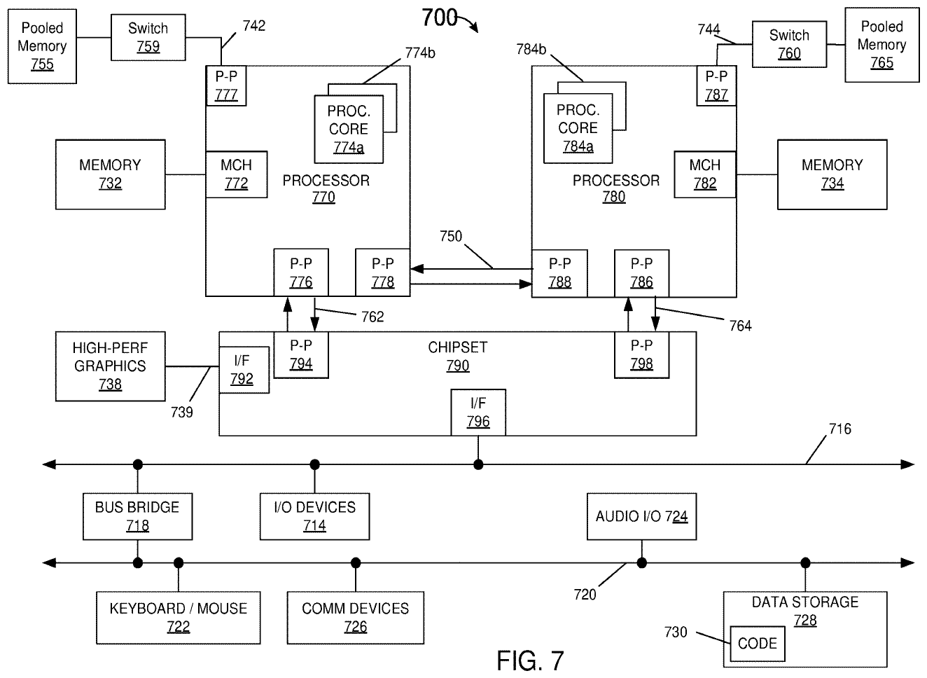

### FIG. 7—Example System

FIG. 7 shows a block diagram of a system 700 in accordance with another embodiment such as an edge platform. In various embodiments, the system 700 may implement some or all of the components, methods, and/or operations described above with reference to FIGS. 1-5.

As shown in FIG. 7, the system 700 includes a first processor 770 and a second processor 780 coupled via an interconnect 750, which in an embodiment can be an optical interconnect that communicates with optical circuitry (which may be included in or coupled to processors 770). As shown in FIG. 7, each of processors 770 and 780 may be many core processors including representative first and second processor cores (e.g., processor cores 774a and 774b and processor cores 784a and 784b).

In the embodiment of FIG. 7, processors 770 and 780 further include point-to point interconnects 777 and 787, which couple via interconnects 742 and 744 (which may be CXL buses) to switches 759 and 760. In turn, switches 759, 760 couple to pooled memories 755 and 765.

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of system memory (e.g., DRAM) locally attached to the respective processors. First processor 770 and second processor 780 may be coupled to a chipset 790 via P-P interconnects 776 and 786, respectively. As shown in FIG. 7, chipset 790 includes P-P interfaces 794 and 798.

Furthermore, chipset 790 includes an interface 792 to couple chipset 790 with a high performance graphics engine 738, by a P-P interconnect 739. As shown in FIG. 7, various input/output (I/O) devices 714 may be coupled to first bus 716, along with a bus bridge 718 which couples first bus 716 to a second bus 720. Various devices may be coupled to second bus 720 including, for example, a keyboard/mouse 722, communication devices 726 and a data storage unit 728 such as a disk drive or other mass storage device which may include code 730, in one embodiment. Further, an audio I/O 724 may be coupled to second bus 720.

### FIG. 8—Example Storage Medium

Referring now to FIG. 8, shown is a storage medium 800 storing executable instructions 810. In some embodiments, the storage medium 800 may be a non-transitory machine-readable medium, such as an optical medium, a semiconductor, a magnetic storage device, and so forth. The executable instructions 810 may be executable by a processing device. Further, the executable instructions 810 may be used by at least one machine to fabricate at least one integrated circuit to perform one or more of the methods and/or operations described above with reference to FIGS. 1-5.

The following clauses and/or examples pertain to further embodiments.

In Example 1, a processor may include a plurality of processing engines, and a plurality of hardware queue manager (HQM) devices. Each HQM device may be to queue data requests for a different subset of the plurality of processing engines. At least one processing engine is to execute a first set of instructions to: detect a first enqueue instruction to enqueue data in a first HQM device of the plurality of HQM devices; in response to a detection of the first enqueue instruction, perform a look-up of the first HQM device in a data structure to determine a recommended port for the first HQM device; and transmit the first enqueue instruction using the recommended port for the first HQM device.

In Example 2, the subject matter of Example 1 may optionally include that one or more processing engines are to execute a second set of instructions to identify a set of HQM devices to be profiled; and for each HQM device of the identified set of HQM devices: transmit at least one test message to each producer port of the HQM device, determine a performance metric for each producer port of the HQM device, identify a recommended port of the HQM device having a best performance metric, and create an entry in the data structure to indicate the recommended port for the HQM device.

In Example 3, the subject matter of Examples 1-2 may optionally include that the data structure is a stored recommendation table to include a plurality of entries, that each entry of the stored recommendation table is to specify a particular HQM device and a recommended port for the particular HQM device, and that the performance metric is a test time.

In Example 4, the subject matter of Examples 1-3 may optionally include that the one or more processing engines are further to execute the second set of instructions to: identify the set of HQM devices to be profiled in response to a detection of a trigger event, where the trigger event is one selected of a boot-up event and a reset event.

In Example 5, the subject matter of Examples 1-4 may optionally include that the first set of instructions is included in one selected from an operating system and a driver for the plurality of HQM devices; and that the second set of instructions is included in firmware of the processor.

In Example 6, the subject matter of Examples 1-5 may optionally include that the first set of instructions and the second set of instructions are both included in one selected from an operating system and a driver for the plurality of HQM devices.

In Example 7, the subject matter of Examples 1-6 may optionally include that the processor comprises a plurality of tiles, and that each tile comprises: a single HQM device; and a subset of the plurality of processing engines.

In Example 8, the subject matter of Examples 1-7 may optionally include that each tile further comprises a caching home agent implemented in circuitry, where each caching home agent is to maintain a distributed cache coherence directory, and where each caching home agent is to be assigned a set of memory addresses that represent a portion of the directory.

In Example 9, the subject matter of Examples 1-8 may optionally include that the first enqueue instruction is to: transmit from a producer processing engine to a first caching home agent that is associated with an address of the recommended port; transmit from the first caching home agent to the recommended port of the first HQM device; transmit from the first HQM device to a second caching home agent; and transmit from the second caching home agent to a consumer processing engine.

In Example 10, a machine-readable medium may store instructions that upon execution cause a processor to: identify a plurality of hardware queue manager (HQM) devices to be profiled, each HQM device to queue data requests for a different subset of a plurality of processing engines; and for each HQM device of the plurality of HQM devices: transmit at least one test message to each producer port of the HQM device; determine a performance metric for each producer port of the HQM device; order the producer ports according to an order of the performance metrics; and create a set of entries in a stored data structure to identify the producer ports of the HQM device in the order of increasing test time.

In Example 11, the subject matter of Example 10 may optionally include that the stored data structure is a recommendation table to include a plurality of entries, that each entry of the recommendation table is to identify a particular producer port of a particular HQM device, and that the performance metric is a test time.

In Example 12, the subject matter of Examples 10-11 may optionally include instructions that upon execution cause the processor to: identify the plurality of HQM devices to be profiled in response to a detection of a trigger event, where the trigger event is one selected of a boot-up event and a reset event.

In Example 13, the subject matter of Examples 10-12 may optionally include instructions that upon execution cause the processor to: detect a first enqueue instruction to enqueue data in a first HQM device of the plurality of HQM devices; in response to a detection of the first enqueue instruction, perform a look-up of the first HQM device in the stored table to determine the recommended port for the first HQM device; and transmit the first enqueue instruction using the recommended port for the first HQM device.

In Example 14, the subject matter of Examples 10-13 may optionally include that the first enqueue instruction is to: transmit from a producer processing engine to a first caching home agent that is associated with an address of the recommended port; transmit from the first caching home agent to the recommended port of the first HQM device; transmit from the first HQM device to a second caching home agent; and transmit from the second caching home agent to a consumer processing engine.

In Example 15, the subject matter of Examples 10-14 may optionally include that each HQM device of the plurality of HQM devices is included in a different tile of a plurality of tiles, and that each tile comprises: a subset of the plurality of processing engines; and a caching home agent implemented in circuitry, where each caching home agent is to maintain a distributed cache coherence directory, and where each caching home agent is to be assigned a set of memory addresses that represent a portion of the directory.

In Example 16, a method may include: identifying, by a first processing engine, a plurality of hardware queue manager (HQM) devices to be profiled, each HQM device to queue data requests for a different subset of a plurality of processing engines; and for each HQM device of the plurality of HQM devices: transmitting, by the first processing engine, at least one test message to each producer port of the HQM device; determining, by the first processing engine, a performance metric for each producer port of the HQM device; ordering, by the first processing engine, the producer ports according to an order of the performance metrics; and creating, by the first processing engine, a set of entries in a stored data structure to identify the producer ports of the HQM device in the order of the performance metrics.

In Example 17, the subject matter of Example 16 may optionally include that the stored data structure is a recommendation table to include a plurality of entries, that each entry of the recommendation table is to identify a particular producer port of a particular HQM device, and that the performance metric is a test time.

In Example 18, the subject matter of Examples 16-17 may optionally include: identifying the plurality of HQM devices to be profiled in response to a detection of a trigger event, where the trigger event is one selected of a boot-up event and a reset event.

In Example 19, the subject matter of Examples 16-18 may optionally include: detecting a first enqueue instruction to enqueue data in a first HQM device of the plurality of HQM devices; in response to a detection of the first enqueue instruction, performing a look-up of the first HQM device in the stored table to determine the recommended port for the first HQM device; and transmitting the first enqueue instruction using the recommended port for the first HQM device.

In Example 20, the subject matter of Examples 16-19 may optionally include: transmitting the first enqueue instruction from a producer processing engine to a first caching home agent that is associated with an address of the recommended port; transmitting the first enqueue instruction from the first caching home agent to the recommended port of the first HQM device; transmitting the first enqueue instruction from the first HQM device to a second caching home agent; and transmitting the first enqueue instruction from the second caching home agent to a consumer processing engine.

In Example 21, the subject matter of Examples 16-20 may optionally include that each HQM device of the plurality of HQM devices is included in a different tile of a plurality of tiles, and that each tile comprises: a subset of the plurality of processing engines; and a caching home agent implemented in circuitry, where each caching home agent is to maintain a distributed cache coherence directory, and where each caching home agent is to be assigned a set of memory addresses that represent a portion of the directory.

In Example 22, a computing device may include: one or more processors; and a memory having stored therein a plurality of instructions that when executed by the one or more processors, cause the computing device to perform the method of any of Examples 16 to 21.

In Example 23, a machine readable medium may have stored thereon data, which if used by at least one machine, causes the at least one machine to fabricate at least one integrated circuit to perform a method according to any one of Examples 16 to 21.

In Example 24, an electronic device may include means for performing the method of any of Examples 16 to 21.

In Example 25, a system may include: a processor and a system memory coupled to the processor, The processor may include a plurality of processing engines and a plurality of hardware queue manager (HQM) devices. At least one processing engine is to execute instructions to: detect a first enqueue instruction to enqueue data in a first HQM device of the plurality of HQM devices; in response to a detection of the first enqueue instruction, perform a look-up of the first HQM device in a stored data structure to determine a recommended port for the first HQM device; and transmit the first enqueue instruction using the recommended port for the first HQM device.

In Example 26, the subject matter of Example 25 may optionally include that one or more processing engines are to execute instructions to: identify a set of HQM devices to be profiled; and for each HQM device of the identified set of HQM devices: transmit at least one test message to each producer port of the HQM device; determine a performance metric for each producer port of the HQM device; identify a recommended port of the HQM device having a best performance metric; and create an entry in the stored data structure to indicate the recommended port for the HQM device.

In Example 27, the subject matter of Examples 25-26 may optionally include that the stored data structure is a recommendation table to include a plurality of entries, that each entry of the recommendation table is to specify a particular HQM device and a recommended port for the particular HQM device, and that the performance metric is a test time.

In Example 28, the subject matter of Examples 25-27 may optionally include that the processor comprises a plurality of tiles, and that each tile comprises: a single HQM device; and a subset of the plurality of processing engines.

In Example 29, the subject matter of Examples 25-28 may optionally include that each tile further comprises a caching home agent implemented in circuitry, that each caching home agent is to maintain a distributed cache coherence directory, and that each caching home agent is to be assigned a set of memory addresses that represent a portion of the directory.

In Example 30, an apparatus may include: means for identifying a plurality of hardware queue manager (HQM) devices to be profiled, each HQM device to queue data requests for a different subset of a plurality of processing engines; and for each HQM device of the plurality of HQM devices: means for transmitting at least one test message to each producer port of the HQM device; means for determining a performance metric for each producer port of the HQM device; means for ordering the producer ports according to an order of the performance metrics; and means for creating a set of entries in a stored data structure to identify the producer ports of the HQM device in the order of the performance metrics.

In Example 31, the subject matter of Example 30 may optionally include that the stored data structure is a recommendation table to include a plurality of entries, that each entry of the recommendation table is to identify a particular producer port of a particular HQM device, and that the performance metric is a test time.

In Example 32, the subject matter of Examples 30-31 may optionally include means for identifying the plurality of HQM devices to be profiled in response to a detection of a trigger event, where the trigger event is one selected of a boot-up event and a reset event.

In Example 33, the subject matter of Examples 30-32 may optionally include: means for detecting a first enqueue instruction to enqueue data in a first HQM device of the plurality of HQM devices; means for, in response to a detection of the first enqueue instruction, performing a look-up of the first HQM device in the data structure to determine the recommended port for the first HQM device; and means for transmitting the first enqueue instruction using the recommended port for the first HQM device.

In Example 34, the subject matter of Examples 30-33 may optionally include: means for transmitting the first enqueue instruction from a producer processing engine to a first caching home agent that is associated with an address of the recommended port; means for transmitting the first enqueue instruction from the first caching home agent to the recommended port of the first HQM device; means for transmitting the first enqueue instruction from the first HQM device to a second caching home agent; and means for transmitting the first enqueue instruction from the second caching home agent to a consumer processing engine.

In Example 35, the subject matter of Examples 30-34 may optionally include that each HQM device of the plurality of HQM devices is included in a different tile of a plurality of tiles, and that each tile comprises: a subset of the plurality of processing engines; and a caching home agent implemented in circuitry, where each caching home agent is to maintain a distributed cache coherence directory, and where each caching home agent is to be assigned a set of memory addresses that represent a portion of the directory.

Some embodiments described herein may provide functionality to identify a port in a HQM device that is recommended for C2C communications in a processor. When a C2C message is to be transmitted to a particular HQM device, the C2C message is transmitted to the recommended port address. In this manner, the performance of C2C communication in the processor may be improved.

Note that, while FIGS. 1-8 illustrate various example implementations, other variations are possible. For example, the examples shown in FIGS. 1-8 are provided for the sake of illustration, and are not intended to limit any embodiments. Specifically, while embodiments may be shown in simplified form for the sake of clarity, embodiments may include any number and/or arrangement of components. For example, it is contemplated that some embodiments may include any number of components in addition to those shown, and that different arrangement of the components shown may occur in certain implementations. Furthermore, it is contemplated that specifics in the examples shown in FIGS. 1-8 may be used anywhere in one or more embodiments.

Understand that various combinations of the above examples are possible. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1-20. (canceled)

21. A processor comprising:
a plurality of processing engines; and
a plurality of hardware queue manager (HQM) devices, each HQM device to queue data requests for a different subset of the plurality of processing engines,
wherein at least one processing engine is to execute a first set of instructions to:
detect a first enqueue instruction to enqueue data in a first HQM device of the plurality of HQM devices;
in response to a detection of the first enqueue instruction, perform a look-up of the first HQM device in a data structure to determine a recommended port for the first HQM device; and
transmit the first enqueue instruction using the recommended port for the first HQM device.

22. The processor of claim 21, wherein one or more processing engines are to execute a second set of instructions to:
identify a set of HQM devices to be profiled;
for each HQM device of the identified set of HQM devices:
transmit at least one test message to each producer port of the HQM device;
determine a performance metric for each producer port of the HQM device;
identify a recommended port of the HQM device having a best performance metric; and
create an entry in the data structure to indicate the recommended port for the HQM device.

23. The processor of claim 22, wherein the data structure is a stored recommendation table to include a plurality of entries, wherein each entry of the stored recommendation table is to specify a particular HQM device and a recommended port for the particular HQM device, and wherein the performance metric is a test time.

24. The processor of claim 22, wherein the one or more processing engines are further to execute the second set of instructions to:
identify the set of HQM devices to be profiled in response to a detection of a trigger event,
wherein the trigger event is one selected of a boot-up event and a reset event.

25. The processor of claim 24, wherein:
the first set of instructions is included in one selected from an operating system and a driver for the plurality of HQM devices; and
the second set of instructions is included in firmware of the processor.

26. The processor of claim 24, wherein:
the first set of instructions and the second set of instructions are both included in one selected from an operating system and a driver for the plurality of HQM devices.

27. The processor of claim 21, wherein the processor comprises a plurality of tiles, and wherein each tile comprises:
a single HQM device; and
a subset of the plurality of processing engines.

28. The processor of claim 27, wherein each tile further comprises a caching home agent implemented in circuitry, wherein each caching home agent is to maintain a distributed cache coherence directory, and wherein each caching home agent is to be assigned a set of memory addresses that represent a portion of the directory.

29. The processor of claim 28, wherein the first enqueue instruction is to:
transmit from a producer processing engine to a first caching home agent that is associated with an address of the recommended port;
transmit from the first caching home agent to the recommended port of the first HQM device;
transmit from the first HQM device to a second caching home agent; and
transmit from the second caching home agent to a consumer processing engine.

30. A machine-readable medium storing instructions that upon execution cause a processor to:
identify a plurality of hardware queue manager (HQM) devices to be profiled, each HQM device to queue data requests for a different subset of a plurality of processing engines;
for each HQM device of the plurality of HQM devices:
transmit at least one test message to each producer port of the HQM device;
determine a performance metric for each producer port of the HQM device;
order the producer ports according to an order of the performance metrics; and
create a set of entries in a stored data structure to identify the producer ports of the HQM device in the order of the performance metrics.

31. The machine-readable medium of claim 30, wherein the stored data structure is a recommendation table to include a plurality of entries, wherein each entry of the recommendation table is to identify a particular producer port of a particular HQM device, and wherein the performance metric is a test time.

32. The machine-readable medium of claim 31, further storing instructions that upon execution cause the processor to:
identify the plurality of HQM devices to be profiled in response to a detection of a trigger event, wherein the trigger event is one selected of a boot-up event and a reset event.

33. The machine-readable medium of claim 30, further storing instructions that upon execution cause the processor to:
detect a first enqueue instruction to enqueue data in a first HQM device of the plurality of HQM devices;
in response to a detection of the first enqueue instruction, perform a look-up of the first HQM device in the stored table to determine the recommended port for the first HQM device; and
transmit the first enqueue instruction using the recommended port for the first HQM device.

34. The machine-readable medium of claim 33, wherein the first enqueue instruction is to:
transmit from a producer processing engine to a first caching home agent that is associated with an address of the recommended port;
transmit from the first caching home agent to the recommended port of the first HQM device; transmit from the first HQM device to a second caching home agent; and
transmit from the second caching home agent to a consumer processing engine.

35. The machine-readable medium of claim 30, wherein each HQM device of the plurality of HQM devices is included in a different tile of a plurality of tiles, and wherein each tile comprises:
a subset of the plurality of processing engines; and
a caching home agent implemented in circuitry,
wherein each caching home agent is to maintain a distributed cache coherence directory, and
wherein each caching home agent is to be assigned a set of memory addresses that represent a portion of the directory.

36. A system comprising:
a processor comprising a plurality of processing engines and a plurality of hardware queue manager (HQM) devices, wherein at least one processing engine is to execute instructions to:
detect a first enqueue instruction to enqueue data in a first HQM device of the plurality of HQM devices;
in response to a detection of the first enqueue instruction, perform a look-up of the first HQM device in a stored data structure to determine a recommended port for the first HQM device; and
transmit the first enqueue instruction using the recommended port for the first HQM device; and
a system memory coupled to the processor.

37. The system of claim 36, wherein one or more processing engines are to execute instructions to: identify a set of HQM devices to be profiled;
for each HQM device of the identified set of HQM devices:
transmit at least one test message to each producer port of the HQM device;
determine a performance metric for each producer port of the HQM device;
identify a recommended port of the HQM device having a best performance metric; and
create an entry in the stored table to indicate the recommended port for the HQM device.

38. The system of claim 37, wherein the stored data structure is a recommendation table to include a plurality of entries, wherein each entry of the recommendation table is to specify a particular HQM device and a recommended port for the particular HQM device, and wherein the performance metric is a test time.

39. The system of claim 36, wherein the processor comprises a plurality of tiles, and wherein each tile comprises:
a single HQM device; and
a subset of the plurality of processing engines.

40. The system of claim 39, wherein each tile further comprises a caching home agent implemented in circuitry, wherein each caching home agent is to maintain a distributed cache coherence directory, and wherein each caching home agent is to be assigned a set of memory addresses that represent a portion of the directory.
